(19) United States
(12) Patent Application Publication
(10) Pub. No.: US 2021/0375156 A1
(43) Pub. Date: Dec. 2, 2021

(54) HYGIENE DOLL APPARATUS AND SYSTEM AND METHODS FOR PRACTICING HYGIENE THEREOF

(71) Applicant: Ligita Howery, Chicago, IL (US)

(72) Inventor: Ligita Howery, Chicago, IL (US)

(21) Appl. No.: 17/335,574

(22) Filed: Jun. 1, 2021

Related U.S. Application Data
(60) Provisional application No. 63/033,054, filed on Jun. 1, 2020.

(51) Int. Cl. G09B 19/00; G09B 5/04; A63H 3/00; A63H 3/28

(52) U.S. Cl. CPC G09B 19/0076; G09B 5/04; G09B 19/0084; A63H 3/28; A63H 3/003

(57) ABSTRACT

A hygiene doll apparatus and system for practicing hygiene and the related methods for training or practicing hygiene on a doll apparatus. The doll apparatus comprises a microprocessor and memory, along with multiple sensors, and may comprise audio and/or video capabilities for instructing the user and tracking the use of the doll apparatus for the practice of, or training for, hygiene techniques, mostly for young children or those with mental or physical handicaps, i.e., students.

### CROSS-REFERENCE TO RELATED APPLICATION

This application claims priority to U.S. Provisional Patent Application No. 63/033,054, filed Jun. 1, 2020, entitled HYGIENE DOLL APPARATUS AND SYSTEM AND METHODS FOR PRACTICING HYGIENE THEREOF, which is hereby incorporated by reference in its entirety as though fully set forth herein.

### FIELD OF THE INVENTION

The present disclosure pertains to a doll apparatus and system for practicing hygiene and the related methods for training or practicing hygiene on a doll apparatus, including proper hand, feet, face, hair and body washing, along with proper use of masks and gloves, among other hygiene procedures. In particular, the apparatus is a doll (or multiple dolls) comprising a microprocessor and memory, and input and output peripherals, including multiple sensors, and may comprise audio and/or video capabilities, including being configured to play and record songs and stories, all for instructing the user on proper hygiene, and recording the actions taken and tracking and reporting the performance of the user in connection with the doll apparatus and system for the practice of, or training for, hygiene techniques, mostly for young children or those with mental or physical handicaps, referred to herein as students, although the hygiene techniques can be taught to anyone.

The doll apparatus may also be coupled to or connected through a wired or wireless connection to a hygiene system that can track and/or record the training steps for review, or can allow a teacher or parent the ability to watch or track the student for accuracy and repetitiveness as the user or student steps through the hygiene process, either in real time or reviewing the historical actions of the student. The hygiene system can include access to the system and methods through a stand-alone computer, a computer connected to the Internet, or a cell phone, and may use a hygiene cell phone application, among other system components.

To the extent that multiple dolls are incorporated into the system instead of a single doll, each of the dolls may be used to teach a particular set of hygiene steps, or a group of hygiene steps. For example, one doll may be used to teach a student or child how to brush one's teeth, while another doll may be used to teach how to wash one's face. Additionally, the doll for teaching the use of a toothbrush may also teach how to use floss and clean one's tongue as a group of instructions. In this embodiment, each of the dolls can be coupled or connected to the hygiene system as described above, and can be purchased separately and later added to the system for that particular user. As disclosed, the hygiene doll apparatus will be described herein as a single doll having multiple processes, but it should be understood that these processes can be divided out into multiple hygiene dolls.

The doll apparatus may be configured through microphone(s), speaker(s) and other input/output (I/O) devices to allow for the recording and playing back of stories and songs, all pertaining to proper hygiene through practicing with the doll. The stories and songs may be prerecorded, downloaded or created by the user (child/student) or the parent/teacher, or a combination of the above. As an example, the doll may play a prerecorded song about washing behind the ears that a child may learn, and then at some later time, a parent may create a new song with the child that pertains to washing behind the ears, and that song may be recorded for playback each time the child uses the doll for hygiene practice.

### BACKGROUND OF THE INVENTION

Dolls have been around for many years and can include numerous categories. For example, fashion dolls are designed to be dressed to reflect fashion trends and are manufactured as toys for children to play with, and as collectibles for collectors. The fashion dolls are usually modeled after teen girls or adult women and are typically made of vinyl or plastic. Children play with dolls and quite often role play as to how they perceive they will act when they get older. Usually, this role playing involves dressing up and interacting with other dolls.

Some dolls, including toilet training dolls, may be anatomically correct for educational purposes. Dolls may also be used as medical models, especially when explaining medical procedures to children. These dolls may have more detailed depictions of the human anatomy and may also include features like removable internal organs for further explanation of a particular medical procedure, when necessary.

It is also well know how important hygiene can be to one's health. Further, some adults may take it for granted that the simple washing and cleaning they do every day may be more difficult for younger children or those having a mental or physical handicap, to understand and perform.

Whereas dolls exist that allow children to play by cleaning and dressing the doll, just as with any other learning processes, the proper hygiene steps and procedures can be easier learned and remembered, and later properly performed, when a child is told the proper steps and those steps are repeated and tracked to make sure they are being done correctly. Further, the learning will occur quicker when the child understands when the steps being performed are correct or when they are incorrect.

What is needed is a doll apparatus and system that provides a child with the steps for performing proper hygiene, including feedback when the steps being performed are not correct. The steps can be monitored, tracked and reports can be generated for real time review or review at a later date and time. The doll apparatus should be coupled or connected to the system, either wired or wirelessly, thereby allowing a teacher or parent the capability of watching, listening and/or tracking the steps being performed for each hygiene lesson. Different hygiene lessons can be taught to the child using stories and songs when necessary, depending on whether the child is simulating rising in the morning, preparing for bedtime or a number of hygiene lessons applicable during the day.

Additionally, a hygiene doll, or multiple hygiene dolls, are needed that teach a child or student, through the repetitive process and by monitoring, recording, tracking and reporting the use of the doll, many of these lifelong skills that also include the proper use of gloves and masks to protect the child or student from becoming infected or infecting others through the transmission of germs. The disclosure herein provides the hygiene doll and the related system to accomplish these needs.

### SUMMARY OF THE INVENTION

The present invention is a hygiene doll apparatus for practicing one's hygiene and the related methods for training or practicing hygiene on the doll apparatus, including monitoring, recording, tracking and reporting the proper washing of the different parts of the body and the proper usage of gloves and masks for reducing the transmission of germs. By recording, tracking and reporting the progress of hygiene procedures, the teacher or parent can determine where additional practice should be provided.

The lessons to be taught to a child or an adult having a mental or physical handicap can include the proper hygiene upon waking up in the morning; prior to eating a meal, after eating a meal, after using the bathroom and preparing to go to bed at night, among others. Some of the particular lessons may include brushing the dolls teeth, washing the dolls hands and other body parts, changing clothes, brushing the dolls hair, etc. Each of these hygiene lessons prepares the child for performing these same procedures on the child himself or herself.

By using songs and stories, both prerecorded and those created by the child and/or teacher, the present apparatus allows the child to easily learn the different steps to follow when practicing good hygiene. For example, a song may be provided that teaches the user to wash from head down to toes. Later, the user may decide that is not the order they want to wash, and they create another song that incorporates how they want to practice proper hygiene. All of this can be accomplished with the parent or teacher's assistance and while keeping track as the child develops these skills.

The present apparatus further includes or comprises a microprocessor and memory, along with numerous sensors located in the proper places so that the doll apparatus will be able to determine when the proper hygiene steps are being performed. For example, a sensor placed behind the ears of the doll can determine if the child practicing proper hygiene and has washed behind the ears before going to bed.

Other sensors, such as temperature sensors can be included so that the hygiene doll will respond if the temperature is too cold (shiver) or too warm (cry, or state that the water is too warm). Further, sensors located in the back of the mouth can determine whether the child has properly brushed the dolls teeth, by accessing and cleaning the back molars. Other sensors can be located throughout the body of the doll for numerous lessons, such as cleaning the neck, armpits and proper wiping techniques (front to back) for when one has a bowel movement or urinates, or cleaning in those areas (private areas).

Sensors can also be implemented to determine when the child has placed gloves on each of the hands and a mask over the mouth and nose of the doll apparatus. Sensors can also be applied to devices external to the doll apparatus, but that are used in conjunction with the doll apparatus for additional proper hygiene steps. For example, a separate (pretend) bottle of sanitizing or disinfecting gel can be incorporated into a routine, so that if the child presses down on the bottle, no gel will be dispensed, but the system will know that the disinfecting step was practiced.

Another embodiment of the present doll apparatus may comprise audio and/or video capabilities. This can be used to record, listen to and watch or track the child during the process, and instruct the child when the procedures are not done properly or congratulate the child when the correct procedures are followed. This correction/congratulations can also be done automatically using the microprocessor and a software program. Further, in situations where time is important (for example, taking twenty seconds or more to wash your hands), music or a song can play during that time to help the user practice the step for the proper amount of time.

Yet another embodiment comprises a doll apparatus that is connected (wired or wirelessly) to a hygiene system. The hygiene system can monitor and track the training steps for review, or allow a teacher or parent to watch or monitor the child for accuracy as the student performs the hygiene lessons. The hygiene system can include access to the process through a stand-alone computer, for example in the child's home, where the parents can monitor without being in the same room.

The hygiene system may also comprise a computer connected to the Internet, where data can be collected and compared to other hygiene doll usage. The hygiene system can also comprise a cell phone, through a hygiene cell phone application, thereby allowing information to be collected through Bluetooth, NFC or another wireless connection protocol. Using the cell phone provides the teacher or parent with easier access to the information provided by the system, including whether the child is taking the proper hygiene steps and for the correct amount of time, among other important information.

Other techniques can be incorporated into the hygiene doll apparatus, including the use of RFID tags, QR codes, and other system components as understood by one having ordinary skill in the art. Additionally, some sensors can be incorporated for more than one purpose. For example, a sensor behind the ear can be used to ensure that the child is washing behind the ear, but also can be used to make sure that a mask is being properly worn by sensing both sensors behind both ears at once.

The preferred embodiment of the present disclosure combines all of the procedures into a single hygiene doll apparatus, however, multiple dolls can be used to teach the different hygiene processes by incorporating the different procedures independently. Each of these multiple dolls can then be incorporated into the hygiene system and be coupled or connected to the system as described herein.

Other objects and advantages of the present invention will become apparent to one having ordinary skill in the art after reading the specification in light of the drawing figures, however, the spirit and scope of the present invention should not be limited to the description of the embodiments contained herein.

### BRIEF DESCRIPTION OF THE DRAWINGS

FIG. 1 shows a hygiene doll apparatus in accordance with an embodiment of the present invention;

FIG. 2 shows a hygiene doll apparatus and system in accordance with an embodiment of the present invention; and

FIG. 3 shows a functional block diagram for a hygiene doll system in accordance with an embodiment of the present invention.

### DETAILED DESCRIPTION OF EMBODIMENTS OF THE INVENTION

As stated above, the objective of the present invention is to allow a student or child to perform the steps or lessons for proper hygiene by using a doll apparatus (or multiple dolls) comprising one or more microprocessors, memories, sensors and various other I/O devices, such as microphones and speakers, all connected to a hygiene doll system as described below. The hygiene doll apparatus is configured to interact with the child or student via voice and other signaling prompts to encourage positive feedback and directions. The sessions can be tracked, monitored and recorded in real time or as a playback, to insure proper cleaning and hygiene techniques. The monitoring can be through wired or wireless connectivity, including Wi-Fi, Bluetooth, and other connectivity.

For ease of reference in this specification, the term user will refer to the child or student that the present disclosure is intended to teach the hygiene procedures and lessons. Additionally, the term teacher will refer to the parent, guardian or teacher, who is intended to assist the user in learning the proper hygiene procedures, and/or who can access the information recorded, stored and tracked by the hygiene system during use.

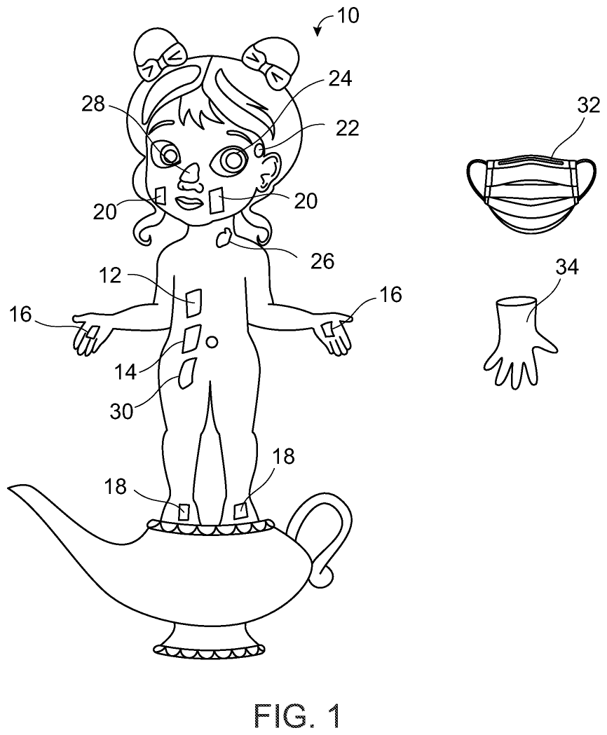

FIG. 1 shows a hygiene doll apparatus 10 that allows a child or an adult with mental or physical limitations or handicaps, to practice and train for proper hygiene procedures using the lessons and methods described herein. The hygiene doll apparatus 10 can be made from numerous materials including plastic, rubber and other materials that can be molded or extruded, and may include PET and PVC. The material must allow for installing and securing various solid state and other devices, such as microprocessors, memory devices and sensors.

Again, although the preferred embodiment of the present disclosure combines all of the procedures into a single hygiene doll apparatus, multiple dolls can be used to teach the different hygiene processes. For example, one doll may be used to teach a student or child how to brush one's teeth (and floss and clean the tongue), while another doll may be used to teach how to wash one's face. Each of the dolls can be coupled or connected to the hygiene system as described above, and can be purchased separately and later added to the system for that particular user.

The lessons to be taught through the use of the hygiene doll apparatus 10 can be through repetitive teaching, storytelling and/or singing songs, and include the proper hygiene upon waking up in the morning (washing up and brushing teeth); prior to eating a meal (washing hands); after eating a meal (brushing teeth); after using the bathroom (washing hands); preparing to go to bed at night (washing body, bathing, brushing teeth), and the proper use of masks (placing on face) and gloves (on and off hands without spreading germs) for protection to prevent the transmission of germs to or from the wearer if they or someone near them sneezes or coughs, among other lessons. Each of these hygiene lessons prepares the child for performing these same procedures on the child him or herself.

Additionally, the repetitive procedures, stories and/or songs can be personalized to incorporate hygiene procedures as those referenced above, including stories and songs about how far germs travel when sneezing, coughing, singing or just talking, and keeping ones hands and fingers away from the face and certain surfaces. Also, why it is important to keep wounds, scrapes, burns and cuts clean and covered so as to not let them become infected. Along those lines, an explanation of how infections can harm you.

Using songs and stories the user can learn why it is good to wash your hands before eating and generally keeping your hands out of your mouth. Also, songs and stories can be used to explain why it is good to bath after being outside, and that you should not sit on your bed after being outside in the same clothes.

The hygiene doll apparatus 10 can be used to explain in a playful way how hygiene can be fun and how one can use different types of soap for example to be creative in the hygiene procedures. And how cleaning one's toys can also help protect yourself and your friends. Additional creativity can be incorporated to explain that the user or child is a personal germ fighting superhero responsible for smashing the germs into smithereens and thereby protecting the planet and ourselves. Finally, the user can be taught how good we look and smell when we are clean.

The doll apparatus 10 includes at least one and possibly multiple microprocessor(s) 12 and at least one memory 14 to hold various software modules. The doll apparatus 10 further comprises hand sensors 16, foot sensors 18, mouth sensors 20, ear sensors 22, and other sensors as needed for teaching various lessons. The doll apparatus 10 may also comprise a video camera 24 (located in the eyes), a microphone 26 and a speaker 28. Among other elements, the doll apparatus 10 may comprise a transmitter and receiver 30, which allows the doll apparatus to send and receive software, signals and/or data pertaining to the use of the hygiene doll apparatus 10 and other signals and data, and other information as necessary to perform the steps of the present invention and receive and transfer that information either through a wired connection or wirelessly, as described below.

To the extent a particular doll apparatus 10 only incorporates a few of the functions or procedures, many of the sensors and other components may not be necessary for those procedures, thereby reducing the cost of each doll apparatus 10.

Separate items such as masks 32 and gloves 34 can be incorporated into the system to teach the user or child about proper placement and location of the mask 32 on the face, and that the gloves 34 are worn properly and importantly, removed without transferring any germs that are on the gloves 34 onto the user's hands. These items 32, 34 and others can also be used in conjunction with the hand sensors 16 and mouth sensors 20 to ensure that the gloves 34 and mask 32, respectively are properly utilized.

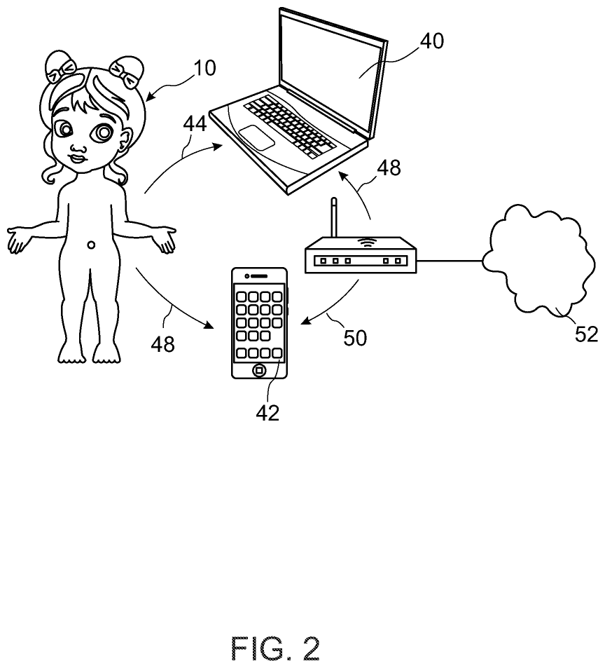

FIG. 2 shows the doll apparatus 10 connected to a computer 40 or a cellular telephone 42 (or both) to implement the steps of the present invention. The hygiene doll apparatus 10 can be connected through a cable 44 to the computer 40, or the doll 10 can send and receive Bluetooth or other wireless signals 46 to or from a cell phone 42 or the computer 40 or other similar access point, such as a Wi-Fi receiver/transmitter. The doll apparatus 10 can send information to the computer 40 or cell phone 42 so that the teacher or parent can monitor the child as the steps are performed for each lesson by using the sensors 16, 18, 20, 22, the video camera 24 and/or the microphone 26. The doll apparatus 10 can receive signals and information from different access points in order to be updated to the latest software versions or to provide communications, for example through the speakers 28. All of these transmissions are performed through the transmitter/receiver 30 located on the hygiene doll apparatus 10.

For example, if the lesson to be performed includes brushing the doll's 10 teeth (not shown), when the child properly brushes the back of the teeth (molars), the mouth sensors 20 will register the proper procedure and send a signal 46 to the teacher, possibly through the cell phone application. If instead, the child does not properly brush the back teeth, the signal will not be sent and the teacher can then instruct the child to “try again, this time brush the back teeth.” The instruction can come from the teacher standing there, or the instruction can be administered verbally through the speaker 28. Further, if the teacher or parent is not standing next to the child performing the lesson, the video camera(s) 24 can record the child's actions for viewing concurrently therewith or at a later time.

As described above, temperature sensors can also be included so that the hygiene doll will respond if the temperature is too cold by shivering, or too warm by crying or stating that the water is too warm. Other sensors can be located throughout the body of the doll for numerous lessons, such as cleaning the neck, armpits and proper wiping techniques (front to back) for when one has a bowel movement or urinates, or cleaning in those areas (private areas). In situations where time is important, for example, taking twenty seconds or longer to wash hands, music or a song can play during that time so that the child can take that much time to wash the hands, etc.

The numerous sensors 16, 18, 20, 22, and others, located in the proper places will allow the system to be able to determine when the proper steps are being performed. The peripheral I/O devices 24, 26, 28 allow real time viewing and interaction with the child as the lessons are performed, or a recording of the lesson for monitoring, reporting and replaying later.

For example, during the bedtime lesson, if the child forgets to clean behind the ears. The sensor placed behind the ears 22 can determine that the child attempting to practice proper hygiene forgot to wash behind the ears. Later, the parent can review the video with the child and explain the steps that were missed. Other sensors can be located throughout the doll apparatus for various lessons.

Additionally, the behind the ears sensors 22 may also be used to ensure that the mask 32 is properly placed on the face and properly behind the ears. As such, sensors can be used for multiple functions and can be used in conjunction with other sensors depending on the procedure to be taught or learned.

As described, these devices 10 allow the teacher or parent to listen using the microphone 26 and watch using the camera 24, or track the child during the process, and instruct the child using the speakers 28 when the procedures are not done properly, or congratulate the child when the correct procedures are followed. This correction/congratulations can also be done automatically using the microprocessor 12 and software code.

As described herein, the doll apparatus 10 can be connected to a hygiene doll system 60, either through a cable 44 or wirelessly 46, which can monitor and track the training steps for review, or allow a teacher or parent to watch or monitor the child for accuracy as the student performs the hygiene lessons. The hygiene doll system 60 may also be connected to the Internet 52 through a connection 48 from the computer 40, or through a cellular network (Bluetooth, Wi-Fi, NFC or another wireless connection protocol) 44 that also can connect the cell phone 42 or other devices. The Internet 52 can then collected data from the various uses and lessons and compare that data to other hygiene doll 10 usage by that same user or from other users.

Other techniques can be incorporated into the hygiene doll apparatus 10, including the use of RFID tags, QR codes, and other system components as understood by one having ordinary skill in the art.

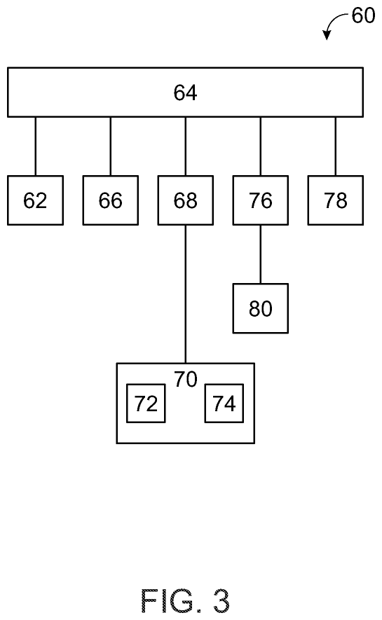

FIG. 3 illustrates an exemplary hygiene doll system 60 functional block diagram or network architecture that may be used to implement the system and methods according to the present invention. The structural elements of the system, as described below, may be an integral part of the hygiene doll apparatus 10 as described above, including the microprocessor 12, memory 14, sensors 16, 18, 20, 22, camera 24, microphone 26, speakers 28 and transmitter/receiver 30. Alternatively, the hygiene doll system 60 described below may be incorporated as a separate component connected to the hygiene doll apparatus 10, either wired or wirelessly through one or more of the many different communication channels described herein. If the hygiene doll system 60 incorporates separate components, the hygiene doll apparatus 10 may not need all of the various elements described herein, as they may be duplicative of the same elements located in the separate component. For reference purposes and to ease understanding, the hygiene doll system 60 is described with different numerals for some of the same elements.

One or more hygiene doll systems 60 may carry out the methods presented herein as computer code allowing the hygiene doll apparatus 10 to interact with the child or student via voice prompts or other signaling prompts. One or more processors, such as processor 62, which may be different from the microprocessor 12 in the hygiene doll apparatus 10, may be a special purpose or a general-purpose processor and is connected to a bus 64. As shown in FIG. 3, bus 62 connects the processor 60 to various other components of the hygiene doll system 60, but it is contemplated bus 64 may connect processor 62 to components (not shown), such as sensors and servomechanisms. It is also contemplated that bus 64 connects the processor 62 to other hygiene doll systems. The processor 62 can receive computer code including updates using the bus 64. The term “computer code” includes, for example, programs, instructions, signals and/or data. The processor 62 can execute the computer code and may further send the computer code via the bus 64.

The hygiene doll system 60 may include one or more memories, such as a first memory 66 and second memory 68. It is contemplated that the first memory 66, secondary memory 68, or a combination thereof, function as a computer usable storage

Medium, to store and/or access the computer code. The first memory 66 and second memory 68 may be, for example, random access memory (RAM), read only memory (ROM), a mass storage device, or any combination thereof.

As also shown in FIG. 3, one embodiment of second memory 68 is a mass storage device 70, although it is contemplated that first memory 66 may be the mass storage device. The mass storage device 70 comprises a storage drive 72 and a storage media 74. It is contemplated that the storage media 74 may or may not be removable from the storage drive 72. Mass storage devices 70 with storage media 74 that are removable, otherwise referred to as removable storage media 74, allow computer code to be transferred to and/or from the hygiene doll system 60.

A mass storage device 70 may include, for example, a Compact Disc Read Only Memory (“CDROM”), ZIP storage device, tape storage device, magnetic storage device, optical storage device, Micro Electro-Mechanical Systems (“MEMS”), nanotechnological storage device, floppy storage device, or a hard disk device, among others, or a combination of these devices. Mass storage device 70 also includes program cartridges and cartridge interfaces (such as that found in video game devices), removable memory chips (such as an EPROM, or PROM) and associated sockets.

The hygiene doll system 60 may further or alternatively include other means for computer code to be loaded into or removed from the hygiene doll system 60, for example, Input/output (“I/O”) interface 76 and/or communications interface 78. Both the I/O interface 76 and the communications interface 78 allow computer code to be transferred between the hygiene doll system 60 and external devices including other hygiene doll systems 60. As with the other transfers, this transfer may be bi-directional or omni-directional to or from the hygiene doll system 60.

Computer code transferred by the I/O interface 76 and the communications interface 78 are typically in the form of signals, which may be electronic, electromagnetic, optical, or other signals capable of being sent and/or received by the interfaces 76, 78. These signals may be transmitted via a variety of modes including, but not limited to, wire or cable, fiber optics, phone line, a cellular phone link, infrared (“IR”), and radio frequency (“RF”) links.

The I/O interface 76 may be any connection, wired or wireless, that allows the transfer of computer code. An I/O interface 76 includes, for example, an analog or digital audio connection, digital video interface (“DVI”), video graphics adapter (“VGA”), musical instrument digital interface (“MIDI”), HDMI, parallel connection, PS/2 connection, serial connection, universal serial bus connection (“USB”), IEEE1394 connection, PCMCIA slot and card. In certain embodiments, the I/O interface 76 connects to an I/O unit 80, such as a user interface, monitor, speaker, printer, touch screen display, among others.

The communications interface 78 is also any connection that allows the transfer of computer code. Communication interfaces 78 include, but are not limited to, a modem, network interface (such as an Ethernet card), wired or wireless systems (such as Wi-Fi, Bluetooth, IR), local area networks, wide area networks, intranets, among others.

The invention is also directed to computer products, otherwise referred to as computer program products, to provide software that includes computer code to the hygiene doll system 60. Processor 62 executes the computer code in order to implement the methods of the present invention. As an example, the methods according to the present invention may be implemented using software that includes the computer code, wherein the software is loaded into the hygiene doll system 60 using a memory 66, 68 such as the mass storage drive 70, or through an I/O interface 76, communications interface 78, or any other interface with the hygiene doll system 60.

The computer code in conjunction with the hygiene doll system 60 described herein may perform any one of, or any combination of, the steps of any of the methods presented herein. It is also contemplated that the methods according to the present invention may be performed automatically, or may be invoked by some form of manual intervention.

The network architecture or functional block diagram of FIG. 3 of the hygiene doll system 60 is provided only for purposes of illustration, such that the present invention is not limited to this specific embodiment. It is appreciated that a person skilled in the relevant art knows how to program and implement the invention using any hygiene doll system 60 or network architecture.

The disclosure embodies a hygiene doll apparatus 10 that allows for a child or adult with mental or physical limitations to practice proper hygiene. As a non-limiting example, if an adult doll apparatus 10 was used instead of the child doll 10 shown, the disclosure would still apply and the scope of the disclosure would cover that alternative.

As such, while the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined herein.

What is claimed is:

1. A hygiene doll apparatus for teaching and practicing proper hygiene, comprising:
a. a doll apparatus, said doll apparatus having limbs a torso and a head;
b. a microprocessor and a memory, said memory capable of storing a hygiene doll computer program, said hygiene doll computer program comprising steps for teaching proper hygiene, said microprocessor capable of performing the steps of the hygiene doll computer program;
c. at least one sensor, said at least one sensor located in one of said limbs, torso or head;
d. at least one peripheral device, said at least one peripheral device being located in said doll apparatus; and
e. a transmitter/receiver, said transmitter/receiver being located in said doll apparatus and configured to send and receive information pertaining to the practice of proper hygiene on the doll apparatus;
wherein when said hygiene doll microprocessor performs the steps of the hygiene doll computer program, a child will be taught to perform proper hygiene on said doll apparatus and when said child performs the required steps, said at least one sensor can determine if said child performed the steps properly, and that information can be transmitted from said doll apparatus through said transmitter/receiver, and
wherein the child can be informed about the proper or improper performance through the at least one peripheral device.

2. The hygiene doll apparatus of claim 1, wherein said steps for teaching proper hygiene include the steps for washing up, brushing teeth, washing hands after using the bathroom, washing body parts, and bathing.

3. The hygiene doll apparatus of claim 1, wherein said steps for teaching proper hygiene include the steps for the proper use of a mask on a face, the proper use of gloves on a hand.

4. The hygiene doll apparatus of claim 1, wherein said at least one sensor includes a contact sensor or a temperature sensors.

5. The hygiene doll apparatus of claim 1, wherein said peripheral device include an input or an output device.

6. The hygiene doll apparatus of claim 5, wherein said input device includes a camera, a video camera or a microphone.

7. The hygiene doll apparatus of claim 5, wherein said output device includes a speaker.
